(19) United States
(12) Patent Application Publication
(10) Pub. No.: US 2022/0326372 A1
(43) Pub. Date: Oct. 13, 2022

(54) BLOCKCHAIN TRANSACTIONS WITH LOCATIONS OBTAINED USING SURFACE-PENETRATING RADAR

(71) Applicant: WaveSense, Inc., Somerville, MA (US)

(72) Inventors: George JORDANIDES, Westwood, MA (US); Connor QUINN, Somerville, MA (US); Thomas CASHMAN, Rowley, MA (US)

(73) Assignee: WaveSense, Inc., Somerville, MA (US)

(21) Appl. No.: 17/715,412

(22) Filed: Apr. 7, 2022

Related U.S. Application Data
(60) Provisional application No. 63/173,710, filed on Apr. 12, 2021.

(51) Int. Cl. G01S 13/88; H04L 9/00

(52) U.S. Cl. CPC G01S 13/885; H04L 9/50

(57) ABSTRACT

Surface-penetrating radar (SPR) systems provide localization information for provision to a blockchain application. SPR can be used in environments, such as cities, where multipath or shadowing degrades GPS accuracy, or as an alternative to optical sensing approaches that cannot tolerate darkness or changing scene illumination or whose performance can be adversely affected by variations in weather conditions. In particular, SPR can be used to acquire scans containing surface and subsurface features as a vehicle traverses terrain, and the acquired data scans may be compared to reference scan data that was previously acquired within the same environment in order to localize vehicle position within the environment. If the reference scan data has been labeled with geographic location information, a vehicle's absolute location can thereby be determined.

### CROSS-REFERENCE TO RELATED APPLICATION

This application claims priority to and the benefit of, and incorporates herein by reference in its entirety, U.S. Provisional Patent Application No. 63/173,710, filed on Apr. 12, 2021.

### FIELD OF THE INVENTION

The present invention relates, generally, to blockchain transactions involving proof of location.

### BACKGROUND

A blockchain is a ledger that maintains a continuously growing list of ordered data blocks. Each block contains a link to a previous block and a timestamp. Once recorded, the data in a block cannot be altered retroactively. The goal of blockchain is to allow digital information to be recorded and distributed, but not edited. Blockchain ledgers are transparent and completely decentralized, which both ensures data integrity (i.e., prevents subsequent editing) and eliminates the need for a central authority. Blockchain maintenance is performed by a network of communicating nodes, which validate transactions, add them to their own local copies of the blockchain, and then broadcast block additions to other nodes. All these operations are performed such that distributed consensus emerges among network nodes in a blockchain exchange. If a forged block is added to the chain, other nodes will recognize and reject the data.

Blockchains can be used in many applications, particularly those involving discrete transactions. The BITCOIN currency, for example, uses blockchain to transparently and immutably record a ledger of payments. Other applications involve establishing sale or transfer records for physical or digital items such as art (or electronic tokens associated with specific artworks or with an artist) and securities, but many others have been proposed. Some envisioned applications involve location-based transactions, such as highway toll payments. A vehicle's current location can be acquired by a navigation system, for example, and geographic coordinates entered into a blockchain—thereby immutably establishing the presence of the vehicle at a toll location, for example. See, e.g., Brambilla et al., “Using Blockchain for Peer-to-Peer Proof of location,” arXiv:1607.00174v2 [cs.DC] 31 Jul. 2017, which is hereby incorporated by reference.

Some “smart contracts”—i.e., self-executing contracts with the terms of the agreement between buyer and seller being directly written into lines of code—require proof of location as a condition to completion. Position-dependent applications can include, for example, consumer transactions in which an online merchant triggers payment only upon proof that a shipped item arrived at the customer's home.

Location information may be useful for blockchain transactions that do not explicitly involve location. Digital signatures are a fundamental building block in blockchains; they are primarily used to verify the authenticity of transactions. A digital signature verifying a transaction may include details of the transaction, for example, but this information may be vulnerable to unauthorized access—e.g., it may be obtained or inferred by someone having unauthorized access to one of the parties' accounts. Consequently, a digital signature may be based in whole or in part on location information, which may be unrelated to the transaction but subject to later verification. In these cases, location is used as a signature feature rather than constituting an element of a contract.

Global positioning system (GPS) receivers are commonly used to provide global localization for navigation systems, and may therefore be used in creating location-based blockchain data. GPS accuracy, however, can degrade severely in certain environments—e.g., where multipath signal patterns or shadowing occur—and GPS signals can easily be blocked or intentionally disrupted by others desiring to interfere with operation. GPS-based systems can be improved with differential signal algorithms or by augmenting the location estimate with inertial sensors, but the resulting systems are typically costly and may require additional infrastructure such as base stations. Such measures may also fail to prevent the increasing threat of GPS spoofing, which occurs when a radio transmitter is used to send a counterfeit GPS signal to a receiver antenna to override a legitimate GPS satellite signal. Most navigation systems are designed to use the strongest GPS signal, and the fake signal overrides the weaker but legitimate satellite signal. GPS spoofing may be particularly attractive to thieves when used to support financial or other transactions.

### SUMMARY

Embodiments of the present invention utilize surface-penetrating radar (SPR) systems to provide localization information for provision to a blockchain application. SPR can be used in environments, such as cities, where multipath or shadowing degrades GPS accuracy, or as an alternative to optical sensing approaches that cannot tolerate darkness or changing scene illumination or whose performance can be adversely affected by variations in weather conditions. It is also difficult to spoof. Whereas GPS is satellite-based, an SPR system generally lies beneath a vehicle, residing just inches above unique and challenging-to-spoof ground signatures, making the signal substantially inaccessible to malefactors. Hence, SPR systems provide reliable sources for obtaining proof of location.

SPR can be used to acquire scans containing surface and subsurface features as a vehicle traverses terrain, and the acquired data scans may be compared to reference scan data that was previously acquired within the same environment in order to localize vehicle position within the environment. If the reference scan data has been labeled with geographic location information, a vehicle's absolute location can thereby be determined.

Accordingly, in a first aspect, the invention pertains to a vehicle-borne system comprising, in various embodiments, an SPR system for acquiring SPR images; a transaction module for obtaining information specifying a transaction request and a blockchain exchange; a computer including a processor and electronically stored instructions, executable by the processor, for computationally identifying a timestamped geographic location using the acquired image and completing the transaction based at least in part on the location; and a network interface for transmitting data to the blockchain exchange for immutable entry therein.

In various embodiments, the transaction module is configured to computationally complete the transaction and the transmitted data details the completed transaction and the corresponding timestamped geographic location. The transaction module may also use the timestamped geographic location to complete the transaction. In some embodiments, the transaction module is configured to obtain the transaction request from a third-party source. In particular, the processor may be configured to obtain transaction data from the third-party source via the network interface and provide the obtained transaction data to the transaction module for processing.

The transaction module may be responsive to commands and data received from a mobile device via the network interface; the received commands and data may specify the transaction request and the blockchain exchange, for example. The the data detailing the completed transaction and the corresponding timestamped geographic location may be provided to the specified blockchain exchange as a single entry.

In a second aspect, the invention relates to a method of performing blockchain transactions. In various embodiments, the method comprises the steps of acquiring a surface-penetrating radar (SPR) image; computationally identifying a timestamped geographic location using the acquired image; obtaining information specifying a transaction request and a blockchain exchange; computationally completing the transaction based at least in part on the location; and transmitting data to the blockchain exchange for immutable entry therein.

The data may be transmitted following computational completion of the transaction and may include details of the completed transaction and the corresponding timestamped geographic location. In various embodiments, the timestamped geographic location is used to complete the transaction. The transaction request may, for example, be obtained wirelessly from a third-party source, e.g., a commercial vendor. Alternatively or in addition, the transaction request may be obtained wirelessly from a mobile device. In some embodiments, the data detailing the completed transaction and the corresponding timestamped geographic location are provided to the specified blockchain exchange as a single entry.

### BRIEF DESCRIPTION OF THE DRAWINGS

The foregoing and the following detailed description will be more readily understood when taken in conjunction with the drawings, in which:

FIG. 1A schematically illustrates an exemplary traveling vehicle including a terrain monitoring system in accordance with embodiments of the invention.

FIG. 1B schematically illustrates an alternative configuration in which the antenna of the terrain monitoring system is closer to or in contact with the surface of the road.

FIG. 2 schematically depicts an exemplary system architecture in accordance with embodiments of the invention.

### DETAILED DESCRIPTION

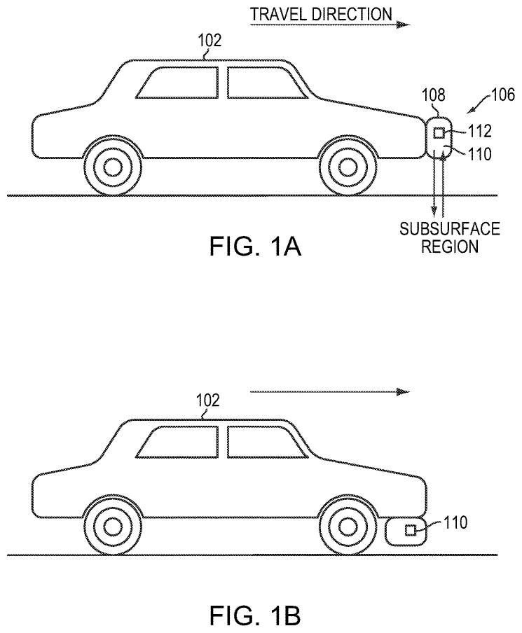

Refer first to FIG. 1, which depicts an exemplary vehicle 102 traveling on a predefined route; the vehicle 102 is provided with a terrain-monitoring system 106 for vehicle navigation in accordance herewith. In various embodiments, the terrain monitoring system 106 includes an SPR navigation and control system 108 having a ground-penetrating radar (GPR) antenna array 110 fixed to the front (or any suitable portion) of the vehicle 102. The GPR antenna array 110 is generally oriented parallel to the ground surface and extends perpendicular to the direction of travel. In an alternative configuration, the GPR antenna array 110 is closer to or in contact with the surface of the road (FIG. 1B). In one embodiment, the GPR antenna array 110 includes a linear configuration of spatially-invariant antenna elements for transmitting GPR signals to the road; the GPR signals may propagate through the road surface into the subsurface region and be reflected in an upward direction. The reflected GPR signals can be detected by the receiving antenna elements in the GPR antenna array 110. In various embodiments, the detected GPR signals are then processed and analyzed in order to generate one or more SPR images (e.g., GPR images) of the subsurface region along the track of the vehicle 102. If the SPR antenna array 110 is not in contact with the surface, the strongest return signal received may be the reflection caused by the road surface. Thus, the SPR images may include surface data, i.e., data for the interface of the subsurface region with air or the local environment. Suitable GPR antenna configurations and systems for processing GPR signals are described, for example, in U.S. Pat. No. 8,949,024, the entire disclosure of which is hereby incorporated by reference.

To obtain localization information, the SPR images are compared to SPR reference images that were previously acquired and stored for subsurface regions that at least partially overlap the subsurface regions for the defined route. The image comparison may be a registration process based on, for example, correlation as described in U.S. Pat. No. 8,786,485, the entire disclosure of which is incorporated by reference herein. The location of the vehicle 102 and/or the terrain conditions of the predefined route can then be determined based on the comparison. In some embodiments, the detected GPR signals are combined with other real-time information, such as the weather conditions, electro-optical (EO) imagery, vehicle health monitoring using one or more sensors employed in the vehicle 102, and any suitable inputs, to estimate the terrain conditions of the predefined route.

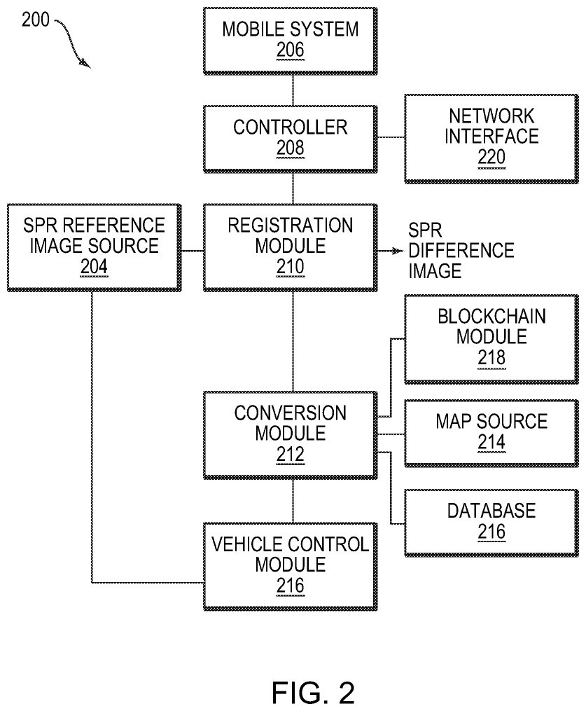

FIG. 2 depicts an exemplary system 200 for obtaining and appending vehicle-location information into a blockchain pursuant, for example, to execution of an agreement or transaction memorialized in the blockchain. The SPR system 108 also includes a mobile SPR system (“Mobile System”) 206 having an SPR antenna array 110. The transmit operation of the mobile SPR system 206 is controlled by a controller (e.g., a processor) 208 that also receives the return SPR signals detected by the SPR antenna array 110. The controller 208 generates SPR images of the subsurface region below the road surface and/or the road surface underneath the SPR antenna array 110.

The SPR image includes features representative of structure and objects within the subsurface region and/or on the road surface, such as rocks, roots, boulders, pipes, voids and soil layering, and other features indicative of variations in the soil or material properties in the subsurface/surface region. In various embodiments, a registration module 210 compares the SPR images provided by the controller 208 to the SPR images retrieved from the SPR reference image source 204 to locate the vehicle 102 (e.g., by determining the offset of the vehicle with respect to the closest point on the route). The location information (e.g., offset data, or positional error data) determined in the registration process is provided to a conversion module 212 that creates a location map for navigating the vehicle 102 and a timestamped instantaneous vehicle location, which is continuously obtained and refreshed. For example, the conversion module 212 may generate an estimated location corrected for the vehicle positional deviation from the route.

Alternatively, the conversion module 212 may retrieve an existing map from a map source 214 (e.g., other navigation systems, such as GPS, or a mapping service), and then localize the obtained locational information to the existing map. In one embodiment, the location map of the predefined route is stored in a database 216 in system memory and/or a storage device accessible to the controller 208. Additionally or alternatively, the location data for the vehicle 104 may be used in combination with the data provided by an existing map (e.g., a map provided by GOOGLE MAPS) and/or one or more other sensors or navigation systems, such as an inertial navigation system (INS), a GPS system, a sound navigation and ranging (SONAR) system, a LIDAR system, a camera, an inertial measurement unit (IMU) and an auxiliary radar system, one or more vehicular dead-reckoning sensors (based on, e.g., steering angle and wheel odometry), and/or suspension sensors to guide the vehicle 102. For example, the controller 112 may localize the obtained SPR information to an existing map generated using GPS. Approaches for utilizing the SPR system for vehicle navigation and localization are described in, for example, the '024 patent mentioned above.

When a blockchain transaction is to take place—for example, when the vehicle approaches and communicates with a toll transponder—a blockchain module 218 may combine the timestamped location information with a vehicle identifier and toll information provided by the transponder, and create a transaction entry for a blockchain. For example, the transponder may “wake up” the system to obtain the the timestamped location so that this information is not continuously collected other than as needed for navigation (if implemented and active). A network interface 220 may communicate wirelessly with a blockchain exchange system to place the transaction entry into the blockchain as a data record. The blockchain module 218 may be programmed to operate autonomously in this fashion when it interacts, via the network interface 220 or otherwise, with a recognized system for which transactions have been pre-authorized. In addition to tolling, the blockchain module 218 may be programmed—e.g., via a user interface 222 or using a mobile device (such as a smart phone or tablet) wirelessly communicating with the blockchain module 218 via the network interface 220—to pre-authorize other forms of transactions involving the vehicle, such as payment for fuel or parking, inspection, vehicle cleaning, etc. These transactions are completed via wireless interaction with a payment server with relevant details, including location, memorialized in the blockchain.

The user may also interact transactionally with the blockchain module 218 using a mobile device communicating via the network interface 220. In particular, a smart phone may exchange data with the network interface 220 using a short-range communication protocol such as Bluetooth or an IEEE 802.11 protocol. The user's mobile device may run an application (“app”) that enables the user to initiate a transaction, such as a virtual-currency payment or contract acceptance, with a third party whose completion is to be memorialized in the blockchain. Authorizing the payment, accepting the contract or otherwise completing a transaction using the app may cause the mobile device to provide data to the blockchain module 218 and instruct it to enter transaction details in a blockchain exchange. In response, the blockchain module 218 obtains the timestamped location information from the conversion module 212, combines it with transaction details provided by the app, and communicates via the network interface 220 with the blockchain exchange specified by the app (or programmed in advance by the user). The user interacting with the mobile app may be the owner of the vehicle or another authorized party, e.g., a ride-share passenger paying for a ride.

In still other embodiments, for security, transactions may take place and the blockchain module 218 triggered using the vehicle-borne user interface 220 rather than a wireless device whose signals could be intercepted.

Location information can be used for blockchain transactions in applications not involving roadway travel. In a warehouse, for example, a robot may be equipped with an SPR system 108. When the robot arrives at a programmed location on the warehouse floor to drop off a package, the SPR image obtained from the sensor when the robot arrives at this location is compared to a stored SPR map (in the map source 214 or in the blockchain) and a location estimate is found by the registration module 210. This location is stored in the blockchain, which in turn completes a smart contract (e.g., causing the package to be unloaded from the robot).

In various embodiments, the actual SPR image rather than a location determined using SPR may be used in blockchain applications; an image may be more difficult to spoof than position data, enhancing security. For example, a sequence of SPR images and their associated positions within the relevant area may be used to create the map source 214, and each SPR image together with its location can be stored in a sequence in the blockchain. The first block in the blockchain (often called the “genesis” block) contains the SPR map of a given area, i.e., a complete sequence of SPR images indexed by their associated locations throughout the area of interest. To complete a transaction at a given location (whether or not the vehicle is actually monitoring its location), the vehicle obtains an SPR image and stores it, either directly or encrypted into a digital signature, in the blockchain. The vehicle's location can later be ascertained by comparison of the stored SPR image with those in the genesis block. Alternatively, the vehicle (e.g., an automobile or warehouse robot) may be location-aware and using the GPR system 108 for navigation. In this case, the vehicle obtains its location as described above, using the registration module 210 to compare an acquired SPR image to images retrieved from the SPR reference image source 204. Once again the vehicle's SPR system 108 may simply store its current SPR image in the blockchain when completing a transaction, or may instead verify the location against the blockchain by using its location to retrieve the corresponding SPR image in the genesis block and performing a comparison, the successful results of which enable transaction completion and storage of the current SPR image in the blockchain.

As is well-understood, a blockchain exchange may include a plurality of nodes each hosting a database with the same blockchain data. Each host's blockchain database is available to the other hosts. The participants in a transaction validate the block entry memorializing the transaction by consensus, according to the terms governing the transaction. That is, the block entry data is broadcast to every node of the blockchain exchange 210, and is verified and properly validated by each host according to a predetermined consensus procedure (which may be specified in a smart contract governing or relating to the transaction). The verification includes ensuring that the data is accurate and has not been tampered with. Because multiple participants play an active role in this consensus decision, the integrity of the data is corroborated across the participating nodes. Once the data to be added to the ledger is validated (i.e., approved by the blockchain exchange), the data or block data is stored on each blockchain database and designated as immutable.

The controller 208 and blockchain module 218 may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A vehicle-borne system comprising:
a surface-penetrating radar (SPR) system for acquiring SPR images;
a transaction module for obtaining information specifying a transaction request and a blockchain exchange;
a computer including a processor and electronically stored instructions, executable by the processor, for computationally identifying a timestamped geographic location using the acquired image and completing the transaction based at least in part on the location; and
a network interface for transmitting data to the blockchain exchange for immutable entry therein.

2. The system of claim 1, wherein the transaction module is configured to computationally complete the transaction and the transmitted data details the completed transaction and the corresponding timestamped geographic location.

3. The system of claim 1, wherein the transaction module is configured to use the timestamped geographic location to complete the transaction.

4. The system of claim 1, wherein the transaction module is configured to obtain the transaction request from a third-party source.

5. The system of claim 4, wherein the processor is configured to obtain transaction data from the third-party source via the network interface and provide the obtained transaction data to the transaction module for processing.

6. The system of claim 1, wherein the transaction module is responsive to commands and data received from a mobile device via the network interface, the received commands and data specifying the transaction request and the blockchain exchange.

7. The system of claim 1, wherein the data detailing the completed transaction and the corresponding timestamped geographic location are provided to the specified blockchain exchange as a single entry.

8. A method of performing blockchain transactions, the method comprising the steps of:
acquiring a surface-penetrating radar (SPR) image;
computationally identifying a timestamped geographic location using the acquired image;
obtaining information specifying a transaction request and a blockchain exchange;
computationally completing the transaction based at least in part on the location; and
transmitting data to the blockchain exchange for immutable entry therein.

9. The method of claim 8, wherein the data is transmitted following computational completion of the transaction and includes details of the completed transaction and the corresponding timestamped geographic location.

10. The method of claim 8, wherein the timestamped geographic location is used to complete the transaction.

11. The method of claim 8, wherein the transaction request is obtained wirelessly from a third-party source.

12. The method of claim 11, wherein the third-party source is a commercial vendor.

13. The method of claim 8, wherein the transaction request is obtained wirelessly from a mobile device.

14. The method of claim 9, wherein the data detailing the completed transaction and the corresponding timestamped geographic location are provided to the specified blockchain exchange as a single entry.
